(19) United States
(12) Patent Application Publication
(10) Pub. No.: US 2023/0054827 A1
(43) Pub. Date: Feb. 23, 2023

(54) INFORMATION PROCESSING APPARATUS AND METHOD AND NON-TRANSITORY COMPUTER READABLE MEDIUM

(71) Applicant: FUJIFILM Business Innovation Corp., Tokyo (JP)

(72) Inventor: Yuki YAMANAKA, Kanagawa (JP)

(73) Assignee: FUJIFILM Business Innovation Corp., Tokyo (JP)

(21) Appl. No.: 17/569,476

(22) Filed: Jan. 5, 2022

(30) Foreign Application Priority Data
Aug. 20, 2021 (JP) 2021-134613

(51) Int. Cl. G06F 21/31

(52) U.S. Cl. CPC G06F 21/31

(57) ABSTRACT

An information processing apparatus includes a processor configured to: receive a predetermined input operation for the information processing apparatus; and perform control to switch a state of a different information processing apparatus from a restricted state to a restriction-removed state in response to receiving of the predetermined input operation, the restricted state being a state in which an input operation for the different information processing apparatus is restricted, the restriction-removed state being a state in which a restriction on the input operation for the different information processing apparatus is removed.

### CROSS-REFERENCE TO RELATED APPLICATIONS

This application is based on and claims priority under 35 USC 119 from Japanese Patent Application No. 2021-134613 filed Aug. 20, 2021.

### BACKGROUND

### (i) Technical Field

The present disclosure relates to an information processing apparatus and method and a non-transitory computer readable medium.

### (ii) Related Art

When a user starts using a wearable terminal, such as a head-mounted display (HMD), augmented reality (AR) glasses, and a smartwatch, the user may be requested to perform authentication to unlock the wearable terminal. Examples of known authentication methods are a password, a personal identification number (PIN), biometric information (such as information on the iris or fingerprints), and a gesture pattern (see Japanese Unexamined Patent Application Publication No. 2016-99702, for example).

### SUMMARY

Authentication using a password or biometric information makes it necessary to add a device for obtaining authentication information to a wearable terminal. This may increase the cost and the size of the wearable terminal. Authentication using a gesture pattern demands that a user make an unnatural action (gesture), which is not practical.

Aspects of non-limiting embodiments of the present disclosure relate to making it possible to perform authentication to unlock a terminal at the start of the use of the terminal by a user without adding a special configuration to the terminal.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: receive a predetermined input operation for the information processing apparatus; and perform control to switch a state of a different information processing apparatus from a restricted state to a restriction-removed state in response to receiving of the predetermined input operation, the restricted state being a state in which an input operation for the different information processing apparatus is restricted, the restriction-removed state being a state in which a restriction on the input operation for the different information processing apparatus is removed.

### BRIEF DESCRIPTION OF THE DRAWINGS

Exemplary embodiments of the present disclosure will be described in detail based on the following figures, wherein:

FIG. 1 is a schematic diagram illustrating the overall configuration of an information processing system to which a first exemplary embodiment is applied;

FIG. 2 is a block diagram illustrating the hardware configuration of a user terminal to which the first exemplary embodiment is applied;

FIG. 3 is a block diagram illustrating the hardware configuration of a head-mounted display (HMD) to which the first exemplary embodiment is applied;

FIG. 4 is a block diagram illustrating the functional configuration of a controller of the user terminal to which the first exemplary embodiment is applied;

FIG. 5 is a block diagram illustrating the functional configuration of a controller of the HMD to which the first exemplary embodiment is applied;

FIG. 6 is a flowchart illustrating processing executed by the user terminal in the first exemplary embodiment from when the user terminal and the HMD are connected to each other until an unlocking instruction is sent from the user terminal to the HMD;

FIG. 7 is a flowchart illustrating processing executed by the HMD in the first exemplary embodiment;

FIG. 8 illustrates specific examples of the positional relationship between the user terminal and the HMD and that between a user and the HMD;

FIG. 9 is a block diagram illustrating the hardware configuration of a user terminal to which a second exemplary embodiment is applied;

FIG. 10 is a block diagram illustrating the functional configuration of a controller of the user terminal to which the second exemplary embodiment is applied;

FIG. 11 is a block diagram illustrating the functional configuration of a controller of an HMD to which the second exemplary embodiment is applied;

FIG. 12 is a flowchart illustrating processing executed by the user terminal in the second exemplary embodiment from when the user terminal and the HMD are connected to each other until an unlocking instruction is sent from the user terminal to the HMD;

FIG. 13 is a flowchart illustrating processing executed by the HMD in the second exemplary embodiment;

FIG. 14 is a schematic diagram illustrating the overall configuration of an information processing system to which a third exemplary embodiment is applied;

FIG. 15 is a block diagram illustrating the hardware configuration of an image processing device to which the third exemplary embodiment is applied; and

FIG. 16 is a block diagram illustrating the functional configuration of a controller of the image processing device to which the third exemplary embodiment is applied.

### DETAILED DESCRIPTION

Exemplary embodiments of the disclosure will be described below in detail with reference to the accompanying drawings.

### First Exemplary Embodiment

### (Configuration of Information Processing System)

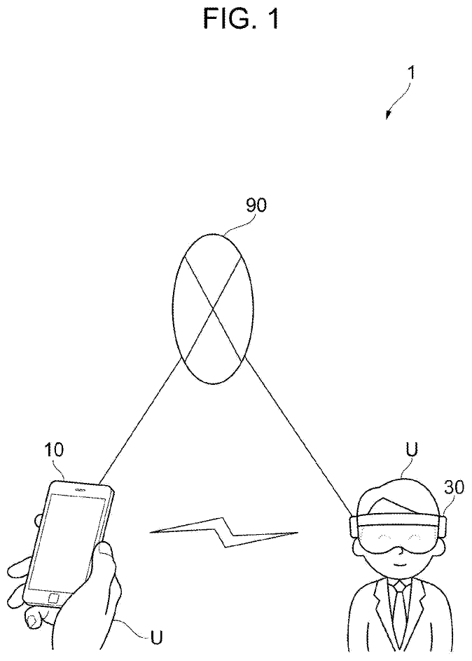

FIG. 1 is a schematic diagram illustrating the overall configuration of an information processing system 1 to which a first exemplary embodiment is applied.

The information processing system 1 includes a user terminal 10 and a head-mounted display (HMD) 30 connected to each other by a network 90 or a communication system, such as infrared, visible light, near field communication (NFC), Bluetooth (registered trademark), radio frequency integrated circuit (RFID) (registered trademark), and ultra-wideband (UWB). The network 90 is a local area network (LAN) or the internet, for example.

The user terminal 10 is an information processing apparatus, such as a smartphone, a personal computer, and a tablet terminal, used by a user U. When the user terminal 10 is connected to the HMD 30, which is in a locked state, and when the HMD 30 is worn on the head of the user U or the HMD 30 is in a state in which it can be assumed to be worn on the head of the user U, the user terminal 10 performs control to unlock the HMD 30 in response to an input operation of the user U.

“Being locked” or “being in the locked state” is a state in which an input operation is restricted. “Being unlocked” or “being in the unlocked state” is a state in which an input operation is not restricted. The input operation of the user U is an input operation performed for the user terminal 10 by the user U. Examples of the input operation of the user U are an operation using dedicated application software installed in the user terminal 10 and an operation using a dedicated website that is accessible by a browser function of the user terminal 10.

The HMD 30 is a head-mounted-type information processing apparatus having a display which displays image information. There are various types of HMDs, such as binocular and monocular types and transparent and non-transparent types. The HMD 30 is not limited to a particular type. If the HMD 30 is a transparent type, the user U can see through the HMD 30 and recognize the user terminal 10. The HMD 30 performs control to send information indicating the state of the HMD 30 to the user terminal 10. Then, in response to an instruction to unlock the HMD 30 from the user terminal 10, the HMD 30 unlocks itself. The user U is then able to start using the HMD 30. The HMD 30 is a device that can be used when it is worn on the head of the user U. Hence, to prevent unauthorized use of the HMD 30 by other users and to save power when the HMD 30 is not worn on the user U, it is desirable to unlock the HMD 30 after it is worn on the head of the user U, as in the first exemplary embodiment.

Examples of information indicating the state of the HMD 30 to be sent from the HMD 30 are: information indicating the position of the HMD 30, the position of the user terminal 10, the position of the user U, the positional relationship between the HMD 30 and the user terminal 10, and the positional relationship between the HMD 30 and the user U; and information indicating a still image or a video image of the user terminal 10 and the user U.

### (Hardware Configuration of User Terminal)

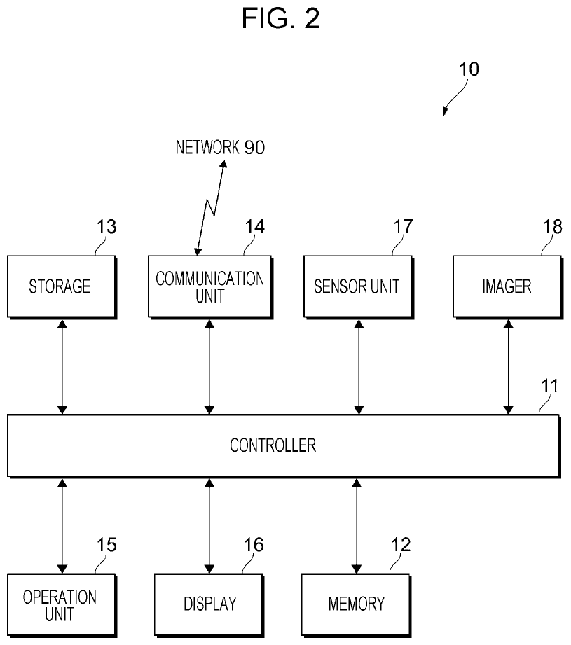

FIG. 2 is a block diagram illustrating the hardware configuration of the user terminal 10 to which the first exemplary embodiment is applied.

The user terminal 10 includes a controller 11, a memory 12, a storage 13, a communication unit 14, an operation unit 15, a display 16, a sensor unit 17, and an imager 18. These elements are connected to each other via a data bus, an address bus, and a peripheral component interconnect (PCI) bus, for example.

The controller 11 is a processor that controls the operation of the user terminal 10 by executing various software programs, such as an operating system (OS) (basic software) and application software. The controller 11 is constituted by a central processing unit (CPU), for example. The memory 12 is a storage region for storing various software programs and data used for the execution of the software programs, and is used as a work area by the controller 11 to execute processing. The memory 12 is constituted by a random access memory (RAM), for example.

The storage 13 is a storage region for storing data to be input into various software programs and data output therefrom and stores a database for storing various items of information. The storage 13 is constituted by a hard disk drive (HDD), a solid state drive (SSD), or a semiconductor memory, for example, used for storing programs and various items of setting data. The communication unit 14 sends and receives data via the network 90 or using a communication system, such as infrared communication system. The communication unit 14 sends and receives data with the HMD 30 and external devices.

The operation unit 15 is constituted by a keyboard, a mouse, a mechanical button, and a switch, for example, and receives an input operation. The operation unit 15 also includes a touch sensor, which integrally forms a touchscreen with the display 16. The display 16 displays image and text information, for example. The display 16 is constituted by a liquid crystal display or an organic electroluminescence (EL) display used for displaying information, for example.

The sensor unit 17 is constituted by various sensors, such as an optical sensor and an acceleration sensor. The sensor unit 17 detects the position of the user terminal 10, the position of the HMD 30, the position of the user U, the positional relationship between the user terminal 10 and the HMD 30, and the position relationship between the HMD 30 and the user U, for example. The imager 18 is constituted by a camera, for example, and images the HMD 30 and the user U.

### (Hardware Configuration of HMD)

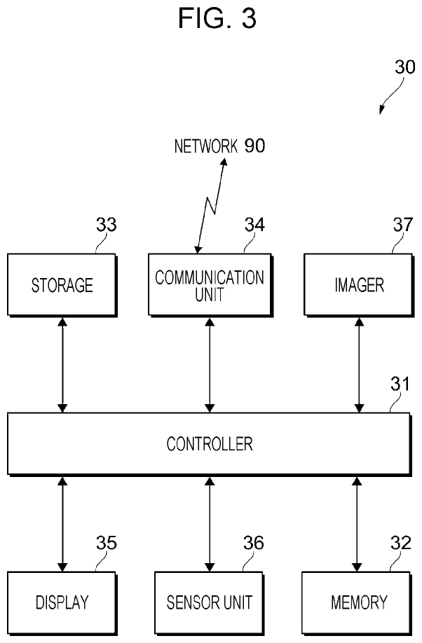

FIG. 3 is a block diagram illustrating the hardware configuration of the HMD 30 to which the first exemplary embodiment is applied.

The configuration of the HMD 30 is similar to that of the user terminal 10 shown in FIG. 2, except that the operation unit 15 is not provided. That is, the HMD 30 includes a controller 31 constituted by a processor, such as a CPU, a memory 32 constituted by a storage region, such as a RAM, and a storage 33 constituted by a storage region, such as an HDD, an SSD, or a semiconductor memory. The HMD 30 also includes a communication unit 34 that sends and receives data with the user terminal 10 via the network 90 or using a communication system, such as an infrared communication system, and a display 35 constituted by a liquid crystal display or an organic EL display. The HMD 30 also includes a sensor unit 36 constituted by various sensors, such as an optical sensor (a LiDAR sensor (light detection and ranging, laser imaging detection and ranging), for example), an acceleration sensor, and a pressure sensor, and an imager 37 constituted by a camera, for example. These elements of the HMD 30 are connected to each other via a data bus, an address bus, and a PCI bus, for example.

### (Functional Configuration of Controller of User Terminal)

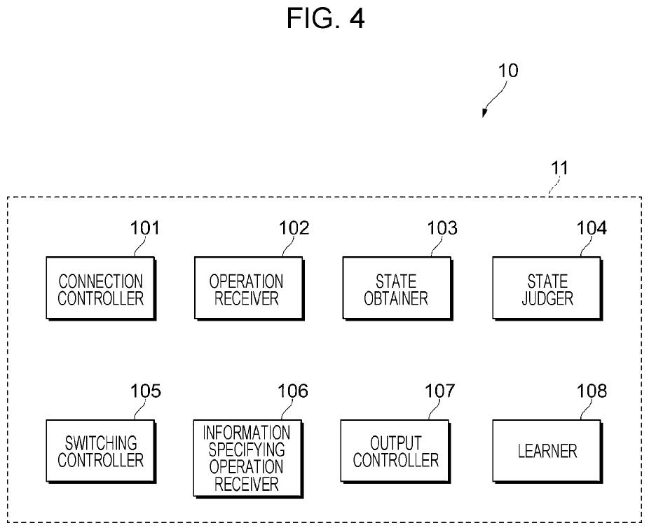

FIG. 4 is a block diagram illustrating the functional configuration of the controller 11 of the user terminal 10 to which the first exemplary embodiment is applied.

The controller 11 of the user terminal 10 functions as a connection controller 101, an operation receiver 102, a state obtainer 103, a state judger 104, a switching controller 105, an information specifying operation receiver 106, an output controller 107, and a learner 108.

The connection controller 101 performs connection control between the user terminal 10 and the HMD 30. More specifically, the connection controller 101 performs control to cause a pair of information processing apparatuses constituted by the user terminal 10 and the HMD 30 to mutually conduct registration and authentication so that they can communicate with each other and call functions. That is, the connection controller 101 controls processing called “pairing”. For example, when the user U with the HMD 30 on the head identifies a quick response (QR) code (registered trademark) displayed on the user terminal 10 through the HMD 30, pairing may be executed automatically. With this configuration, only an authenticated user U can unlock the HMD 30. For example, when a user U1 is performing an operation for unlocking the user terminal 10, even if a user U2 wearing another HMD 30 is near the user U1, the user terminal 10 is not paired with the HMD 30 of the user U2, thereby preventing a leakage of information.

The operation receiver 102 receives an input operation. The input operation includes an operation for unlocking the user terminal 10 and other operations. Examples of the operation for unlocking the user terminal 10 are swiping on the screen, performing authentication using biometric information, such as face authentication and fingerprint authentication, and setting a lock pattern or inputting a personal identification number (PIN).

An example of the operation other than that for unlocking the user terminal 10 is a predetermined operation performed for unlocking the HMD 30 after the user terminal 10 is unlocked. Examples of this predetermined operation are pressing a button, which is used for unlocking the HMD 30, displayed on the display 16, imaging a symbol, which is used for unlocking the HMD 30, formed on part of the surface of the HMD 30, and vibrating the user terminal 10 from side to side near the HMD 30.

Regarding the operation for unlocking the user terminal 10, whether to unlock both of the user terminal 10 and the HMD 30 or to unlock only the HMD 30 may be determined in the following manner. When the operation accompanied by relatively simple processing, such as swiping on the screen of the user terminal 10, is performed, only the HMD 30 may be unlocked. When the operation accompanied by relatively complicated processing, such as authentication using biometric information, is performed, both of the user terminal 10 and the HMD 30 may be unlocked. Whether to unlock both of the user terminal 10 and the HMD 30 or to unlock only the HMD 30 may be determined based on the state of the user terminal 10. For example, when an instruction is given from the user terminal 10, both of the user terminal 10 and the HMD 30 may be unlocked. Without an instruction from the user terminal 10, only the HMD 30 may be unlocked.

Likewise, regarding the operation other than that for unlocking the user terminal 10, whether to unlock both of the user terminal 10 and the HMD 30 or to unlock only the user terminal 10 may be determined in the following manner. When the operation accompanied by relatively simple processing is performed, only the user terminal 10 may be unlocked. When the operation accompanied by relatively complicated processing is performed, both of the user terminal 10 and the HMD 30 may be unlocked.

The state obtainer 103 obtains information indicating the state of the HMD 30. More specifically, as information indicating the state of the HMD 30, the state obtainer 103 obtains the detection results of the sensor unit 17 and also information indicating a still image or a video image of the HMD 30 and the user U captured by the imager 18. As information indicating the state of the HMD 30, the state obtainer 103 also obtains the detection results of the sensor unit 36 of the HMD 30 and information indicating a still image or a video image of the user terminal 10 and the user U captured by the imager 37 of the HMD 30.

The state judger 104 judges the state of the HMD 30, based on information indicating the state of the HMD 30 obtained by the state obtainer 103 and the learning results of the learner 108. More specifically, the state judger 104 judges whether the HMD 30 is locked or unlocked. The state judger 104 also judges whether the HMD 30 is worn on the head of the user U or the HMD 30 is in a state in which it can be assumed to be worn on the head of the user U.

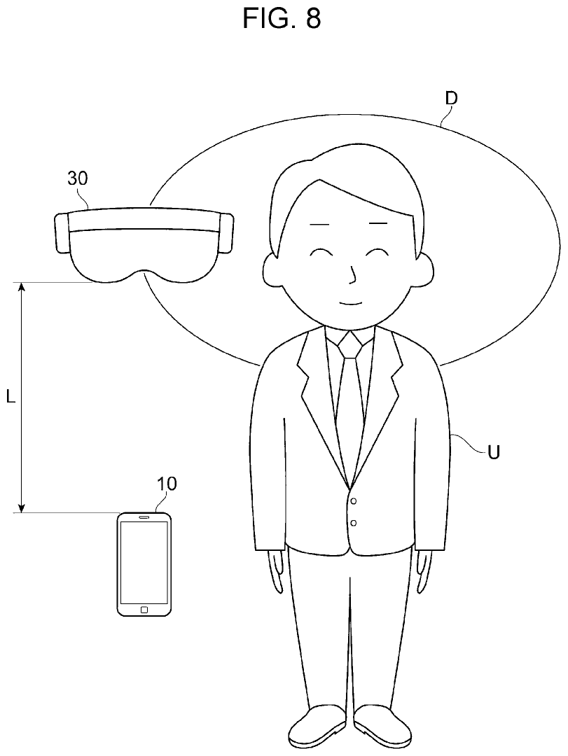

The state judger 104 makes the second judgement in the following manner. When the HMD 30 and the user U have a predetermined positional relationship, the state judger 104 judges that the HMD 30 is worn on the head of the user U or the HMD 30 is in a state in which it can be assumed to be worn on the head of the user U. When the HMD 30 and the user U do not have the predetermined positional relationship, the state judger 104 judges that the HMD 30 is not worn on the head of the user U or the HMD 30 is not in a state in which it can be assumed to be worn on the head of the user U. A specific example in which the HMD 30 and the user U have the predetermined positional relationship will be discussed later with reference to FIG. 8.

When the HMD 30 and the user terminal 10 have a predetermined positional relationship, the state judger 104 judges that the HMD 30 is worn on the head of the user U or the HMD 30 is in a state in which it can be assumed to be worn on the head of the user U. When the HMD 30 and the user terminal 10 do not have the predetermined positional relationship, the state judger 104 judges that the HMD 30 is not worn on the head of the user U or the HMD 30 is not in a state in which it can be assumed to be worn on the head of the user U.

The judgement as to whether the HMD 30 and the user terminal 10 have the predetermined positional relationship may be made by using a combination of the LiDAR sensor of the sensor unit 36 of the HMD 30 and UWB positioning in the communication unit 14 of the user terminal 10. More specifically, the position of the user terminal 10 is identified, based on the UWB positioning result and the estimation result that a rectangular object detected by the LiDAR sensor is the user terminal 10 (a smartphone, for example). If a still image or a video image captured by the imager 37 of the HMD 30 contains the user terminal 10, the positional relationship between the HMD 30 and the user terminal 10 may be identified from the position and the size of the user terminal 10. A specific example in which the HMD 30 and the user terminal 10 have the predetermined positional relationship will be discussed later with reference to FIG. 8.

The switching controller 105 performs control to switch the state of the HMD 30 from the locked state to the unlocked state, based on the judging result of the state judger 104. More specifically, the switching controller 105 sends an unlocking instruction to the HMD 30 to switch the state of the HMD 30 from the locked state to the unlocked state. The switching controller 105 also performs control to switch the state of the HMD 30 from the unlocked state to the relocked state, based on the judging result of the state judger 104. More specifically, the switching controller 105 sends a relocking instruction to the HMD 30 to switch the state of the HMD 30 from the unlocked state to the relocked state.

The information specifying operation receiver 106 receives a user operation for specifying information to be output from the HMD 30 after the HMD 30 is unlocked. The output controller 107 performs control so that the HMD 30 outputs information specified by the input operation of the user U received by the information specifying operation receiver 106. More specifically, the output controller 107 performs control to display text information or image information on the display 35 and to output audio information from a speaker, for example.

If information (notification information, for example) output from the user terminal 10 is specified as information to be output from the HMD 30, the HMD 30 may be used as a sub-display of the user terminal 10. If information to be output from the user terminal 10 includes a certain item of information that the user U does not wish to output to the HMD 30 (confidential information, for example), such an item of information may be omitted from objects to be output from the HMD 30.

The learner 108 performs machine learning using the history of judging processing of the state judger 104, the history of switching control processing of the switching controller 105, and information concerning the usual usage mode of the user U. Machine learning is conducted by artificial intelligence (AI). Examples of information concerning the usual usage mode are: information indicating the positional relationship between the user terminal 10 and the HMD 30, which is detected on a regular basis by the sensor unit 17 of the user terminal 10 and the sensor unit 36 of the HMD 30; information indicating the positional relationship between the HMD 30 and the user U, which is obtained on a regular basis by the imager 18 of the user terminal 10 and the imager 37 of the HMD 30; and the average time taken for the user U to wear and remove the HMD 30 and the average period of time for which the user U uses the HMD 30, which are detected by the sensor unit 36 of the HMD 30. The learning results of the learner 108 are used for the judgement made by the state judger 104.

### (Functional Configuration of HMD)

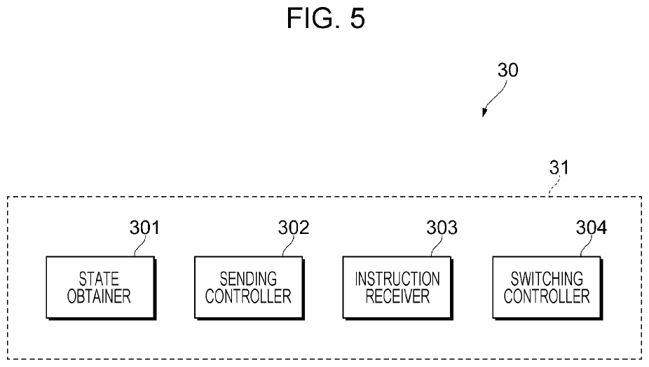

FIG. 5 is a block diagram illustrating the functional configuration of the controller 31 of the HMD 30 to which the first exemplary embodiment is applied.

The controller 31 of the HMD 30 functions as a state obtainer 301, a sending controller 302, an instruction receiver 303, and a switching controller 304.

The state obtainer 301 obtains information indicating the state of the HMD 30. More specifically, as information indicating the state of the HMD 30, the state obtainer 301 obtains the detection results of the sensor unit 36 and information indicating a still image or a video image of the user terminal 10 and the user U captured by the imager 37. The sending controller 302 performs control to send information indicating the state of the HMD 30 obtained by the state obtainer 301 to the user terminal 10.

The instruction receiver 303 receives an unlocking instruction sent from the user terminal 10. The instruction receiver 303 also receives a relocking instruction sent from the user terminal 10. In response to the instruction receiver 303 having received an unlocking instruction, the switching controller 304 switches the state of the HMD 30 from the locked state to the unlocked state. In response to the instruction receiver 303 having received a relocking instruction, the switching controller 304 switches the state of the HMD 30 from the unlocked state to the relocked state.

### (Processing of User Terminal)

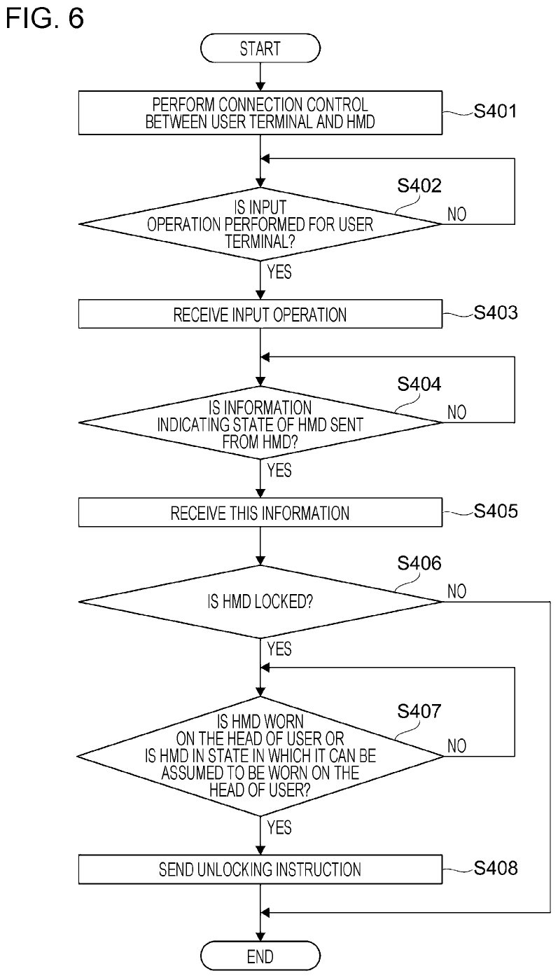

FIG. 6 is a flowchart illustrating processing executed by the user terminal 10 from when the user terminal 10 and the HMD 30 are connected to each other until an unlocking instruction is sent from the user terminal 10 to the HMD 30.

In step S401, the user terminal 10 performs connection control between the user terminal 10 and the HMD 30. More specifically, the user terminal 10 performs control to cause a pair of information processing apparatuses constituted by the user terminal 10 and the HMD 30 to mutually conduct registration and authentication so that they can communicate with each other and call functions (that is, they enter the pairing state).

When an input operation is performed for the user terminal 10 (YES in step S402), the user terminal 10 receives this input operation in step S403. If no input operation is performed for the user terminal 10 (NO in step S402), the user terminal 10 repeats step S402 until an input operation is performed for the user terminal 10.

When information indicating the state of the HMD 30 is sent to the user terminal 10 (YES in step S404), the user terminal 10 receives this information in step S405. If information indicating the state of the HMD 30 is not sent to the user terminal 10 (NO in step S404), the user terminal 10 repeats step S404 until such information is sent to the user terminal 10.

If it is judged based on the state of the HMD 30 that the HMD 30 is locked (YES in step S406) and if it is judged that the HMD 30 is worn on the head of the user U or the HMD 30 is in a state in which it can be assumed to be worn on the head of the user U (YES in step S407), in step S408, the user terminal 10 sends an unlocking instruction. More specifically, in step S408, the user terminal 10 sends this instruction to perform control to switch the state of the HMD 30 from the locked state to the unlocked state. If the HMD 30 is not locked (NO in step S406), the user terminal 10 terminates the processing.

If the HMD 30 is found to be locked (YES in step S406) and if the HMD 30 is not worn on the head of the user U or is not in a state in which the HMD 30 can be assumed to be worn on the head of the user U (NO in step S407), the user terminal 10 repeats step S407 until it is judged that the HMD 30 is worn on the head of the user U or the HMD 30 is in a state in which it can be assumed to be worn on the head of the user U.

### (Processing of HMD)

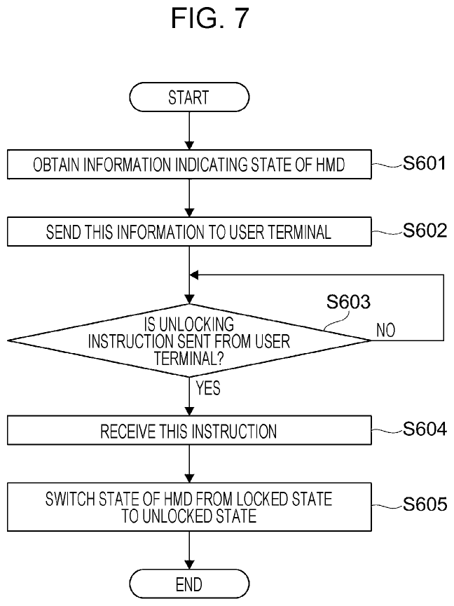

FIG. 7 is a flowchart illustrating processing executed by the HMD 30.

In step S601, the HMD 30 obtains information indicating the state of the HMD 30. In step S602, the HMD 30 sends this information to the user terminal 10. If an unlocking instruction is sent from the user terminal 10 (YES in step S603), the HMD 30 receives this unlocking instruction in step S604. The HMD 30 then switches the state of the HMD 30 from the locked state to the unlocked state in step S605. If no unlocking instruction is sent from the user terminal 10 (NO in step S603), the HMD 30 repeats step S603 until an unlocking instruction is sent from the user terminal 10.

### SPECIFIC EXAMPLES

FIG. 8 illustrates specific examples of the positional relationship between the user terminal 10 and the HMD 30 and that between the user U and the HMD 30.

As discussed above, if it is judged that the HMD 30 is worn on the head of the user U or the HMD 30 is in a state in which it can be assumed to be worn on the head of the user U, an unlocking instruction is sent from the user terminal 10 to the HMD 30. This judgement may be made according to whether the HMD 30 and the user U have a predetermined positional relationship or the HMD 30 and the user terminal 10 have a predetermined positional relationship.

As shown in FIG. 8, for example, when the distance L between the HMD 30 and the user U is smaller than or equal to a predetermined value, it is judged that the HMD 30 is worn on the head of the user U or the HMD 30 is in a state in which it can be assumed to be worn on the head of the user U. In contrast, when the distance L between the HMD 30 and the user U exceeds the predetermined value, it is judged that the HMD 30 is not worn on the head of the user U or the HMD 30 is not in a state in which it can be assumed to be worn on the head of the user U.

When the HMD 30 and the user terminal 10 have a predetermined top-bottom positional relationship, it is judged that the HMD 30 is worn on the head of the user U or the HMD 30 is in a state in which it can be assumed to be worn on the head of the user U. In contrast, when the HMD 30 and the user terminal 10 do not have the predetermined top-bottom positional relationship, it is judged that the HMD 30 is not worn on the head of the user U or the HMD 30 is not in a state in which it can be assumed to be worn on the head of the user U.

The predetermined top-bottom positional relationship is based on the assumption that the head of the user U is positioned on the top side and the feet of the user U are positioned on the bottom side. Even when the user U lies on the bed, the head of the user U is the top side and the feet of the user U are the bottom side. The approach to making the above-described judgement using the predetermined top-bottom positional relationship is based on the assumption that the HMD 30 is worn on the head of the user U, while the user terminal 10 is usually operated with a hand at a lower position than the head of the user U.

If it is judged that the unlocked HMD 30 is not worn on the head of the user U or the unlocked HMD 30 is not in a state in which it can be assumed to be worn on the head of the user U, a relocking instruction is sent from the user terminal 10 to the HMD 30. In response to the relocking instruction, the HMD 30 relocks itself. However, if the HMD 30 is relocked immediately after the above-described judgement is made, it may impair the convenience of the user U. For example, if the eyes of the user U suddenly become itchy after the user U has worn the HMD 30 and the HMD 30 is unlocked, the user U may temporarily remove the HMD 30 and rub the eyes with the hand. In such a situation, it is not appropriate to immediately relock the HMD 30.

From this point of view, the user terminal 10 does not relock the HMD 30 until a predetermined time elapses after it is judged that the HMD 30 is not worn on the head of the user U or the HMD 30 is not in a state in which it can be assumed to be worn on the head of the user U. Any desired time may be set as the predetermined time. For example, a particular time, such as five or ten seconds, may be preset, or the user U may be able to set a desired time.

Even when it is judged that the HMD 30 is not worn on the head of the user U or the HMD 30 is not in a state in which it can be assumed to be worn on the head of the user U, if the position of the HMD 30 does not extend from a predetermined area, the user terminal 10 does not relock the HMD 30. For example, as shown in FIG. 8, if the position of the HMD 30 remains within a predetermined area D near the head of the user U, the user terminal 10 does not relock the HMD 30. Any desired size may be set as the predetermined area. For example, a certain distance from the outer side of the head (30 cm or 50 cm, for example) may be preset, or the user U may be able to set a desired value.

### Second Exemplary Embodiment

In the above-described first exemplary embodiment, the state of the HMD 30 is judged by the user terminal 10. In a second exemplary embodiment, the state of the HMD 30 is judged by the HMD 30.

### (Configuration of Information Processing System)

The configuration of the information processing system 1 to which the second exemplary embodiment is applied and the hardware configuration of the HMD 30 forming the information processing system 1 are similar to those of the first exemplary embodiment, and an explanation thereof is thus omitted.

### (Hardware Configuration of User Terminal)

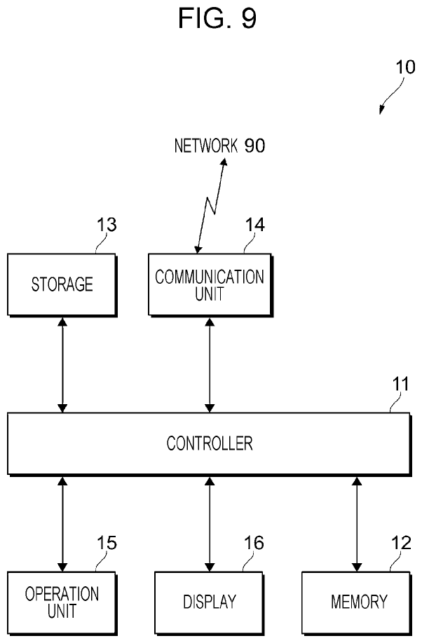

FIG. 9 is a block diagram illustrating the hardware configuration of the user terminal 10 to which the second exemplary embodiment is applied.

The configuration of the user terminal 10 is similar to that of the user terminal 10 shown in FIG. 2, except that the sensor unit 17 and the imager 18 are not provided. That is, the user terminal 10 includes a controller 11 constituted by a processor, such as a CPU, a memory 12 constituted by a storage region, such as a RAM, and a storage 13 constituted by a storage region, such as an HDD, an SSD, or a semiconductor memory. The user terminal 10 also includes a communication unit 14 that sends and receives data with the HMD 30 via the network 90 or using a communication system, such as an infrared communication system, an operation unit 15 constituted by a keyboard, a mouse, a mechanical button, and a switch, for example, and a display 16 constituted by a liquid crystal display or an organic EL display. These elements of the user terminal 10 are connected to each other via a data bus, an address bus, and a PCI bus, for example.

### (Functional Configuration of Controller of User Terminal)

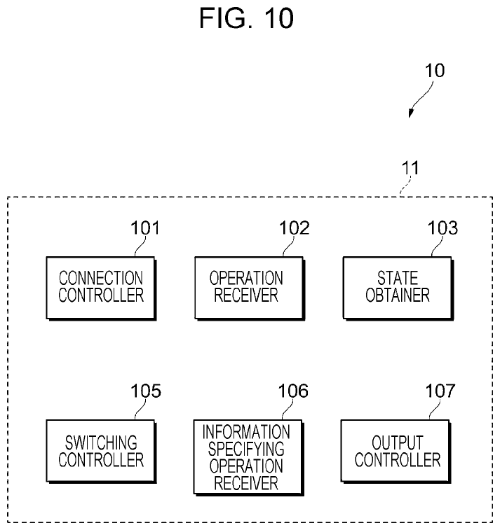

FIG. 10 is a block diagram illustrating the functional configuration of the controller 11 of the user terminal 10 to which the second exemplary embodiment is applied.

The functional configuration of the controller 11 of the user terminal 10 in the second exemplary embodiment is similar to that of the controller 11 of the user terminal 10 shown in FIG. 4, except that the state judger 104 and the learner 108 are not provided. That is, the controller 11 of the user terminal 10 in the second exemplary embodiment functions as a connection controller 101 that performs connection control between the user terminal 10 and the HMD 30, an operation receiver 102 that receives an input operation, a state obtainer 103, a switching controller 105, an information specifying operation receiver 106, and an output controller 107. The information specifying operation receiver 106 receives a user operation for specifying information to be output from the HMD 30. The output controller 107 performs control to output the specified information from the HMD 30.

When information indicating that the HMD 30 is worn on the head of the user U or the HMD 30 is in a state in which it can be assumed to be worn on the head of the user U is sent from the HMD 30, the state obtainer 103 obtains this information. When information indicating that the HMD 30 is no longer worn on the head of the user U or the HMD 30 is no longer in a state in which it can be assumed to be worn on the head of the user U is sent from the HMD 30, the state obtainer 103 obtains this information.

When information indicating that the HMD 30 is no longer worn on the head of the user U or the HMD 30 is no longer in a state in which it can be assumed to be worn on the head of the user U is obtained by the state obtainer 103, the switching controller 105 performs control to switch the state of the HMD 30 from the unlocked state to the relocked state. More specifically, the switching controller 105 sends a relocking instruction to the HMD 30 to switch the state of the HMD 30 from the unlocked state to the relocked state.

### (Functional Configuration of HMD)

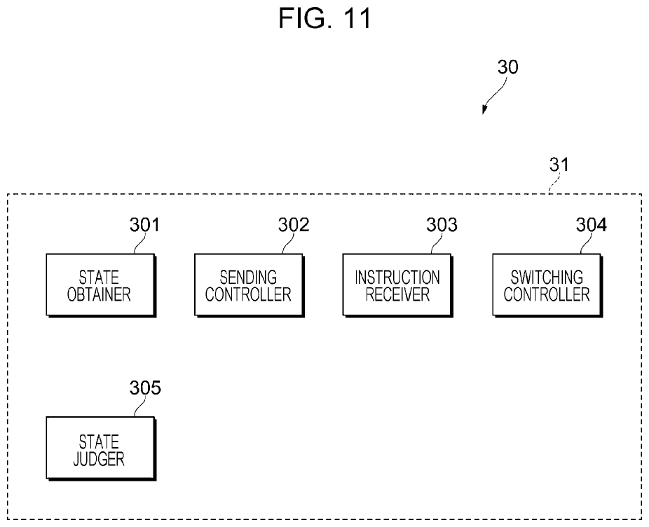

FIG. 11 is a block diagram illustrating the functional configuration of a controller 31 of the HMD 30 to which the second exemplary embodiment is applied.

The functional configuration of the controller 31 of the HMD 30 in the second exemplary embodiment is similar to that of the controller 31 of the HMD 30 shown in FIG. 5, except that a state judger 305 is provided. That is, the controller 31 of the HMD 30 functions as a state obtainer 301 that obtains information indicating the state of the HMD 30, a sending controller 302 that performs control to send information indicating the state of the HMD 30 to the user terminal 10, an instruction receiver 303 that receives an unlocking instruction and a relocking instruction, a switching controller 304 that performs control to switch the state of the HMD 30 from the locked state to the unlocked state or from the unlocked state to the relocked state, and a state judger 305.

The state judger 305 judges the state of the HMD 30, based on information obtained by the state obtainer 301. More specifically, the state judger 305 judges whether the HMD 30 is locked or unlocked. The state judger 305 also judges whether the HMD 30 is worn on the head of the user U or the HMD 30 is in a state in which it can be assumed to be worn on the head of the user U. More specifically, the state judger 305 makes this judgement, based on the detection results of various sensors, such as an optical sensor, an acceleration sensor, and a pressure sensor, of the sensor unit 36 and information indicating a still image or a video image of the user terminal 10 and the user U captured by the imager 37.

The sending controller 302 performs control to send information indicating whether the HMD 30 is locked or unlocked, which is determined based on the judging result of the state judger 305, to the user terminal 10. The sending controller 302 also performs control to send information indicating that the HMD 30 is worn on the head of the user U or the HMD 30 is in a state in which it can be assumed to be worn on the head of the user U, which is determined based on the judging result of the state judger 305, to the user terminal 10.

### (Processing of User Terminal)

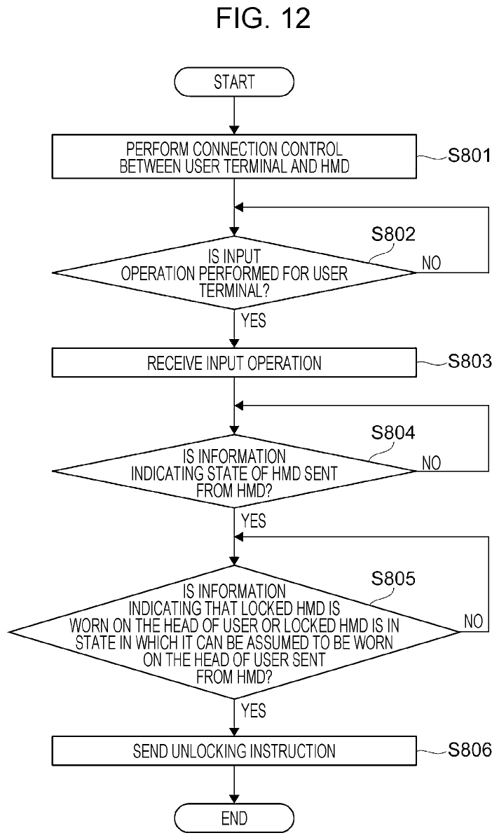

FIG. 12 is a flowchart illustrating processing executed by the user terminal 10 in the second exemplary embodiment from when the user terminal 10 and the HMD 30 are connected to each other until an unlocking instruction is sent from the user terminal 10 to the HMD 30.

Steps S801 through S804 in FIG. 12 are similar to steps S401 through S404 in FIG. 6, and an explanation thereof is thus omitted.

If information indicating that the locked HMD 30 is worn on the head of the user U or the locked HMD 30 is in a state in which it can be assumed to be worn on the head of the user U is sent from the HMD 30 (YES in step S805), the user terminal 10 sends an unlocking instruction to the HMD 30 in step S806. In contrast, if information indicating that the locked HMD 30 is worn on the head of the user U or the locked HMD 30 is in a state in which it can be assumed to be worn on the head of the user U is not sent from the HMD 30 (NO in step S805), the user terminal 10 repeats step S805 until such information is sent from the HMD 30.

### (Processing of HMD)

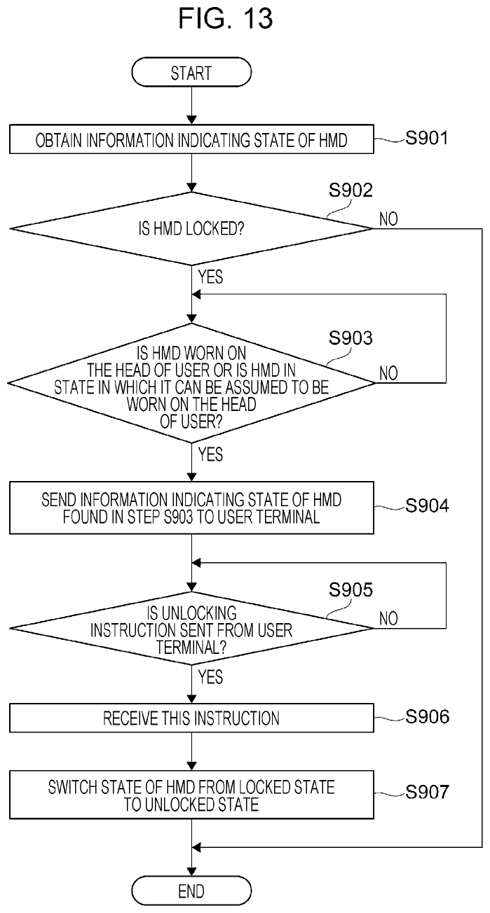

FIG. 13 is a flowchart illustrating processing executed by the HMD 30 in the second exemplary embodiment.

In step S901, the HMD 30 obtains information indicating the state of the HMD 30. The HMD 30 judges the state of the HMD 30 based on this information. If the HMD 30 is found to be locked (YES in step S902) and if the HMD 30 is worn on the head of the user U or the HMD 30 is in a state in which it can be assumed to be worn on the head of the user U (YES in step S903), in step S904, the HMD 30 performs control to send information indicating the state of the HMD 30 found in step S903 to the user terminal 10. In contrast, if the HMD 30 is found to be unlocked (NO in step S902), the HMD 30 terminates the processing.

If the HMD 30 is found to be locked (YES in step S902) and if the HMD 30 is not worn on the head of the user U or the HMD 30 is not in a state in which it can be assumed to be worn on the head of the user U (NO in step S903), the user terminal 10 repeats step S903 until it is judged that the HMD 30 is worn on the head of the user U or the HMD 30 is in a state in which it can be assumed to be worn on the head of the user U.

When an unlocking instruction is sent from the user terminal 10 (YES in step S905), the HMD 30 receives this unlocking instruction in step S906. The HMD 30 then switches the state of the HMD 30 from the locked state to the unlocked state in step S907. If no unlocking instruction is sent from the user terminal 10 (NO in step S905), the HMD 30 repeats step S905 until an unlocking instruction is sent from the user terminal 10.

### Third Exemplary Embodiment

A third exemplary embodiment is different from the first and second exemplary embodiments in the configuration of an information processing system.

### (Configuration of Information Processing System)

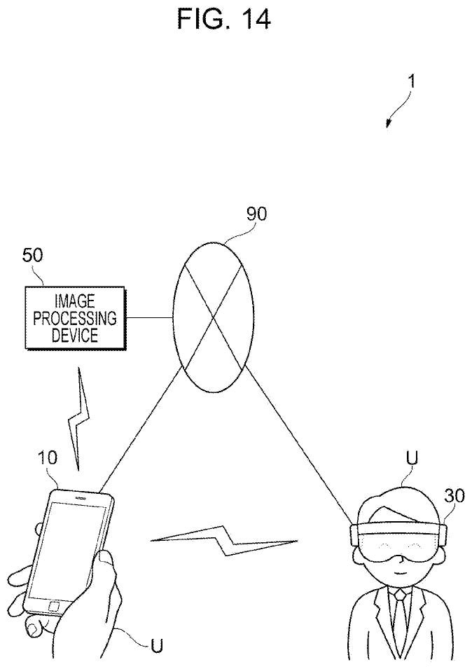

FIG. 14 is a schematic diagram illustrating the overall configuration of an information processing system 1 to which a third exemplary embodiment is applied.

The information processing system 1 incorporating the third exemplary embodiment includes an image processing device 50 in addition to the elements of the information processing system 1 of the first and second exemplary embodiments. The image processing device 50 has various functions, such as a function of forming an image on a recording medium, a function of reading an image formed on a recording medium, and a function of sending and receiving image information by communication.

### (Hardware Configurations of User Terminal, HMD, and Image Processing Device)

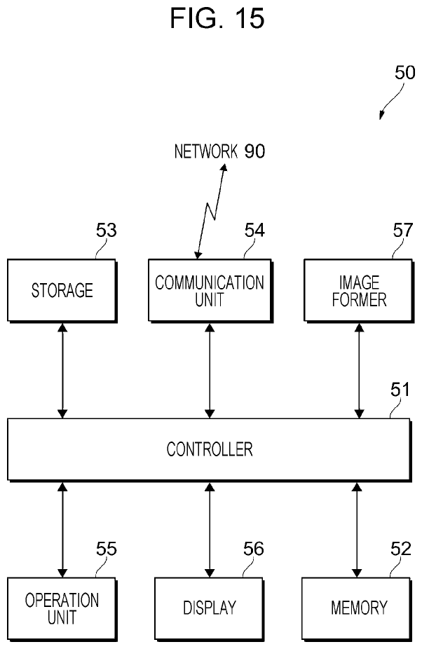

FIG. 15 is a block diagram illustrating the hardware configuration of the image processing device 50 in the third exemplary embodiment.

The hardware configurations of the user terminal 10 and the HMD 30 in the third exemplary embodiment are similar to those of the first and second exemplary embodiments, and an explanation thereof is thus omitted.

The hardware configuration of the image processing device 50 is similar to that of the user terminal 10 shown in FIG. 2, except that the sensor unit 17 and the imager 18 are not provided and that an image former 57 is provided.

That is, the image processing device 50 includes a controller 51 constituted by a processor, such as a CPU, a memory 52 constituted by a storage region, such as a RAM, and a storage 53 constituted by a storage region, such as an HDD, an SSD, or a semiconductor memory. The image processing device 50 also includes a communication unit 54 that sends and receives data with the user terminal 10 and the HMD 30 via the network 90 or using a communication system, such as an infrared communication system, an operation unit 55 that receives an input operation, a display 56 constituted by a liquid crystal display or an organic EL display, and an image former 57. These elements of the image processing device 50 are connected to each other via a data bus, an address bus, and a PCI bus, for example.

The image former 57 forms an image on a recording medium. More specifically, the image former 57 forms an image based on image information on a recording medium, such as a sheet, by using an electrophotographic system that forms a toner image on a sheet or an inkjet system that ejects ink onto a sheet.

### (Functional Configurations of Controllers of User Terminal,

HMD, and Image Processing Device)

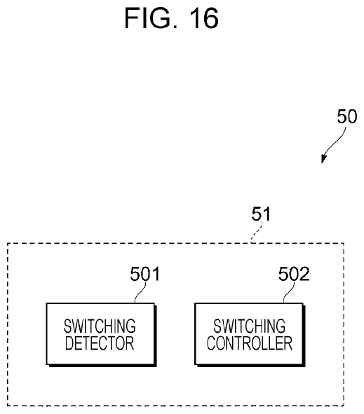

FIG. 16 is a block diagram illustrating the functional configuration of the controller 51 of the image processing device 50 in the third exemplary embodiment.

The functional configurations of the controllers of the user terminal 10 and the HMD 30 in the third exemplary embodiment are similar to those of the first and second exemplary embodiments, and an explanation thereof is thus omitted.

The controller 51 of the image processing device 50 functions as a switching detector 501 and a switching controller 502.

The switching detector 501 detects that the HMD 30 is to be unlocked and that the HMD 30 is to be relocked. As discussed above, in the first and second exemplary embodiments, the HMD 30 is unlocked in response to an unlocking instruction sent from the user terminal 10 to the HMD 30, and the HMD 30 is relocked in response to a relocking instruction sent from the user terminal 10 to the HMD 30. In the third exemplary embodiment, the switching detector 501 detects that the HMD 30 is to be unlocked and that the HMD 30 is to be relocked. The detection result is used as information for unlocking or relocking the HMD 30.

Based on the detection result of the switching detector 501, the switching controller 502 switches the state of the HMD 30 from the locked state to the unlocked state or from the unlocked state to the relocked state. More specifically, if the detection result of the switching detector 501 indicates that the HMD 30 is to be unlocked, the switching controller 502 unlocks the locked HMD 30. If the detection result of the switching detector 501 indicates that the HMD 30 is to be relocked, the switching controller 502 relocks the unlocked HMD 30.

With the above-described functional configuration of the controller 51 of the image processing device 50, the following use cases, for example, can be implemented.

The user U having the locked user terminal 10 in the hand and wearing the locked HMD 30 on the head approaches the image processing device 50. The user U then performs an operation for unlocking the user terminal 10 and the HMD 30. It is assumed that the user U has unlocked the user terminal 10 and the HMD 30 by performing an operation for unlocking the user terminal 10 while viewing the user terminal 10 through the HMD 30.

This will be explained more specifically. First, when the user U with the user terminal 10 in the hand approaches the image processing device 50, the user terminal 10 and the image processing device 50 are connected to each other. The user terminal 10 and the image processing device 50 may be connected automatically or manually. Examples of a communication system used for connecting the user terminal 10 and the image processing device 50 are a system using infrared, visible light, NFC, Bluetooth (registered trademark), and RFID (registered trademark). When the user terminal 10 and the HMD 30 are unlocked by an input operation of the user U, the image processing device 50 is sequentially unlocked.

In a similar use case, it is assumed that the user U has unlocked the HMD 30 by performing an operation other than the operation for unlocking the user terminal 10. In this case, when the HMD 30 is unlocked, information required for unlocking the image processing device 50 is displayed on the display 56 of the image processing device 50. For example, information, such as an unlocking button for unlocking the image processing device 50, an instruction to input a PIN, and a QR code (registered trademark), is displayed. The user U unlocks the image processing device 50 by pressing the unlocking button or inputting a PIN or reading the QR code (registered trademark) by using the user terminal 10 connected to the image processing device 50. In the above-described use cases, only the user U, who is an authenticated user operating the user terminal 10 connected to the image processing device 50 can unlock the image processing device 50.

In this manner, various approaches may be employed to perform an operation on the user terminal 10 for unlocking the image processing device 50. The image processing device 50 may be unlocked on different levels according to the approach used by the user U. For example, when the user U has unlocked the user terminal 10 and the HMD 30 by performing the operation for unlocking the user terminal 10 while viewing the user terminal 10 through the HMD 30, all the functions of the image processing device 50 may be unlocked. When the user U has unlocked the HMD 30 by an approach other than the above-descried operation, only some of the functions of the image processing device 50 may be unlocked. In this case, information displayed on the display 56 of the image processing device 50 may be changed. For example, the contents of all files are displayed on the display 56 of the image processing device 50, while only the front covers of files are displayed on the display 56.

Although the exemplary embodiments have been discussed above, the disclosure is not restricted thereto. The system configurations shown in FIGS. 1 and 14, the hardware configurations shown in FIGS. 2, 3, 9, and 15, and the functional configurations shown in FIGS. 4, 5, 10, 11, and 16 are only examples and are not limited to those shown in the drawings. The information processing systems 1 shown in FIGS. 1 and 14 may only each include functions that can implement the above-described processing as a whole. The functional configurations for implementing such functions are not limited to those shown in FIGS. 4, 5, 10, 11, and 16.

The orders of steps shown in FIGS. 6, 7, 12, and 13 are only examples and are not limited to those in FIGS. 6, 7, 12, and 13. The operations in steps shown in FIGS. 6, 7, 12, and 13 may not necessarily be executed in chronological order and may be executed in parallel or individually. The specific examples of the positional relationship between the user terminal 10 and the HMD 30 and that between the user U and the HMD 30 shown in FIG. 8 are only examples and are not limited to those in FIG. 8.

In the above-described exemplary embodiments, only one HMD 30, which serves as a different information processing apparatus, is provided. However, plural different information processing apparatuses may be provided for the single user terminal 10, which serves as an information processing apparatus.

The image processing device 50 in the third exemplary embodiment does not have a function of obtaining the state of the image processing device 50. As in the HMD 30, however, the image processing device 50 may include a sensor unit and an imager to obtain the state of the image processing device 50. In this case, as in the HMD 30, it is possible to perform control to switch the state of the image processing device 50 from the locked state to the unlocked state and from the unlocked state to the relocked state.

In the above-described exemplary embodiments, when information to be output from the HMD 30 is specified, the content of information to be output from the user terminal 10 and that from the HMD 30 can be made different from each other. In this case, the content of information to be output from the HMD 30 may be made different in accordance with the input operation of the user U. For example, when the user U has unlocked the HMD 30 by performing the operation for unlocking the user terminal 10 while viewing the user terminal 10 through the HMD 30, the same information as that output from the user terminal 10 may be output from the HMD 30. In contrast, when the user U has unlocked the HMD 30 by performing an operation other than the above-descried operation, only notification information may be output from the HMD 30 by omitting detailed information.

In the above-described exemplary embodiments, the operation for unlocking the HMD 30, which is a glasses-type wearable terminal, is performed on the user terminal 10. This operation may alternatively be performed on another wearable terminal. As such a wearable terminal, various types of wearable terminals, such as a watch-type wearable terminal called a smartwatch, and ring-type, shoe-type, pocket-type, and pendant-type wearable terminals, may be used. If a watch-type wearable terminal is used to unlock the HMD 30, a PIN may be input into the watch-type wearable terminal or biometric information of the user U may be authenticated by using the watch-type wearable terminal. Alternatively, a symbol may be formed on part of the surface of the watch-type wearable terminal and be read by the HMD 30.

Alternatively, when the HMD 30 and the watch-type wearable terminal have a predetermined positional relationship and continuously have this relationship for a predetermined time, the HMD 30 may be unlocked. In this case, position information of the watch-type wearable terminal may be used. Usually, the user U wears a watch-type wearable terminal on the wrist for a longer time than when the user U carries the user terminal 10, such as a smartphone, in the hand. The watch-type wearable terminal is positionally closer to the user U than the user terminal 10 is. Additionally, the watch-type wearable terminal is attached to the wrist of the user U so that it can easily obtain biometric information of the user U, which can be used for position information. Hence, position information of the watch-type wearable terminal may be handled as more reliable information than that of the user terminal 10, such as a smartphone.

In this manner, the HMD 30 can be unlocked by the input operation on a watch-type wearable terminal. If the user U has the user terminal 10, such as a smartphone, in the hand and wears a watch-type wearable terminal on the wrist, the HMD 30 may be unlocked by either one of the input operation on the user terminal 10 and that on the watch-type wearable terminal.

In this case, the type and the content of information displayed on the HMD 30 when the HMD 30 is unlocked may be made different according to the type of input operation for unlocking the HMD 30 and also the type of terminal used for performing the input operation. For example, if a user has unlocked the HMD 30 by inputting a PIN into the user terminal 10, it is not guaranteed that this user is the authenticated user U, and only notification information may be displayed on the HMD 30. If a user has unlocked the user terminal 10 and the HMD 30 by performing the operation for unlocking the user terminal 10 while viewing the user terminal 10 through the HMD 30, it is guaranteed that this user is the authenticated user U, and all items of information may be displayed on the HMD 30. If it is more natural to display information only on the user terminal 10, no information may be displayed on the HMD 30. If a user has unlocked the HMD 30 by performing an input operation on a watch-type wearable terminal, it is guaranteed that this user is the authenticated user U, and all items of information may be displayed on the HMD 30.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

The following are translated claims of the priority Japanese patent application intended to support possible divisional patent applications.

16. An information processing apparatus comprising: a processor configured to:
perform control to send information indicating that the information processing apparatus is in a predetermined state to a different information processing apparatus when the information processing apparatus has entered the predetermined state; and
switch a state of the information processing apparatus from a restricted state to a restriction-removed state based on information sent from the different information processing apparatus, the restricted state being a state in which an input operation for the information processing apparatus is restricted, the restriction-removed state being a state in which a restriction on the input operation for the information processing apparatus is removed.

17. The information processing apparatus according to Claim 16, wherein the predetermined state is a state in which a positional relationship between the information processing apparatus and the different information processing apparatus satisfies a predetermined condition.

18. The information processing apparatus according to Claim 17, wherein the predetermined condition is a condition that the information processing apparatus and the different information processing apparatus have a predetermined top-bottom positional relationship.

19. The information processing apparatus according to Claim 16, wherein the predetermined state is a state in which a positional relationship between the information processing apparatus and a user of the information processing apparatus satisfies a predetermined condition.

20. The information processing apparatus according to Claim 19, wherein the predetermined condition is a condition that a distance between the information processing apparatus and the user is smaller than or equal to a predetermined threshold value.

21. The information processing apparatus according to Claim 19, wherein the predetermined condition is a condition that the information processing apparatus is worn on the user.

24. A non-transitory computer readable medium storing a program causing a computer to execute a process, the process comprising:
performing control to send information indicating that the information processing apparatus is in a predetermined state to a different information processing apparatus when the information processing apparatus has entered the predetermined state; and
switching a state of the information processing apparatus from a restricted state to a restriction-removed state based on information sent from the different information processing apparatus, the restricted state being a state in which an input operation for the information processing apparatus is restricted, the restriction-removed state being a state in which a restriction on the input operation for the information processing apparatus is removed.

What is claimed is:

1. An information processing apparatus comprising:
a processor configured to:
receive a predetermined input operation for the information processing apparatus; and
perform control to switch a state of a different information processing apparatus from a restricted state to a restriction-removed state in response to receiving of the predetermined input operation, the restricted state being a state in which an input operation for the different information processing apparatus is restricted, the restriction-removed state being a state in which a restriction on the input operation for the different information processing apparatus is removed.

2. The information processing apparatus according to claim 1, wherein the processor is configured to perform control, when the different information processing apparatus is in a predetermined state and also in the restricted state, to switch the state of the different information processing apparatus from the restricted state to the restriction-removed state in response to the receiving of the predetermined input operation for the information processing apparatus.

3. The information processing apparatus according to claim 2, wherein the predetermined state is a state in which a positional relationship between the different information processing apparatus and a user of the different information processing apparatus satisfies a predetermined condition.

4. The information processing apparatus according to claim 3, wherein the predetermined condition is a condition that a distance between the different information processing apparatus and the user is smaller than or equal to a predetermined value.

5. The information processing apparatus according to claim 3, wherein the predetermined condition is a condition that the different information processing apparatus is worn on the user.

6. The information processing apparatus according to claim 2, wherein the predetermined state is a state in which a positional relationship between the different information processing apparatus and the information processing apparatus satisfies a predetermined condition.

7. The information processing apparatus according to claim 6, wherein the predetermined condition is a condition that the different information processing apparatus and the information processing apparatus have a predetermined top-bottom positional relationship.

8. The information processing apparatus according to claim 2, wherein the processor is configured to perform control, when information indicating that the different information processing apparatus is in the predetermined state is received from the different information processing apparatus, to switch the state of the different information processing apparatus from the restricted state to the restriction-removed state in response to the receiving of the predetermined input operation for the information processing apparatus.

9. The information processing apparatus according to claim 8, wherein the information indicating that the different information processing apparatus is in the predetermined state is information indicating an image captured by the different information processing apparatus.

10. The information processing apparatus according to claim 2, wherein the processor is configured to perform control, when the information processing apparatus detects that the different information processing apparatus is in the predetermined state, to switch the state of the different information processing apparatus from the restricted state to the restriction-removed state in response to the receiving of the predetermined input operation for the information processing apparatus.

11. The information processing apparatus according to claim 10, wherein the information processing apparatus detects that the different information processing apparatus is in the predetermined state, based on information indicating an image of the different information processing apparatus captured by the information processing apparatus.

12. The information processing apparatus according to claim 2, wherein the processor is configured to perform control, after the state of the different information processing apparatus has been switched from the restricted state to the restriction-removed state, to switch the state of the different information processing apparatus from the restriction-removed state to the restricted state when the different information processing apparatus becomes no longer in the predetermined state.

13. The information processing apparatus according to claim 12, wherein the processor is configured to perform control, after the state of the different information processing apparatus has been switched from the restricted state to the restriction-removed state, to switch the state of the different information processing apparatus from the restriction-removed state to the restricted state when the different information processing apparatus is continuously no longer in the predetermined state for a predetermined time.

14. The information processing apparatus according to claim 1, wherein the processor is configured to perform control to output information from the different information processing apparatus when the state of the different information processing apparatus is switched from the restricted state to the restriction-removed state, the information to be output from the different information processing apparatus being different from information output from the information processing apparatus.

15. The information processing apparatus according to claim 14, wherein the information to be output from the different information processing apparatus is information specified by a user.

16. An information processing method comprising:
receiving a predetermined input operation for the information processing apparatus; and
performing control to switch a state of a different information processing apparatus from a restricted state to a restriction-removed state in response to receiving of the predetermined input operation, the restricted state being a state in which an input operation for the different information processing apparatus is restricted, the restriction-removed state being a state in which a restriction on the input operation for the different information processing apparatus is removed.

17. A non-transitory computer readable medium storing a program causing a computer to execute a process, the process comprising:
receiving a predetermined input operation for the information processing apparatus; and
performing control to switch a state of a different information processing apparatus from a restricted state to a restriction-removed state in response to receiving of the predetermined input operation, the restricted state being a state in which an input operation for the different information processing apparatus is restricted, the restriction-removed state being a state in which a restriction on the input operation for the different information processing apparatus is removed.
